(19) United States
(12) Patent Application Publication
(10) Pub. No.: US 2022/0374591 A1
(43) Pub. Date: Nov. 24, 2022

(54) SYSTEMS AND METHODS FOR DYNAMICALLY RENDERING CONTENT BASED ON A TEMPLATE

(71) Applicant: SHOPIFY INC., Ottawa (CA)

(72) Inventor: Amal AL SALAMI, Kanata (CA)

(21) Appl. No.: 17/326,077

(22) Filed: May 20, 2021

(51) Int. Cl. G06F 40/186; G06F 40/106; G06F 40/143; G06F 40/197; G06F 16/958; G06F 16/957

(52) U.S. Cl. CPC G06F 40/186; G06F 40/106; G06F 40/143; G06F 40/197; G06F 16/958; G06F 16/9577

(57) ABSTRACT

A method and system rendering content based on a template are described. The method may include: receiving a rendering request for a webpage, the rendering request comprising a template identification (ID) and a reference to a list of content; retrieving a template based on the template ID, the template comprising one or more sections; retrieving a respective content body for each of the one or more sections in the template, based on the list of content; determining that a respective content body for a first section from the one or more sections does not contain substantive content; an responsive to determining that the respective content body for the first section does not contain substantive content, causing a render of the webpage to omit the first section from a display of the one or more sections on the webpage.

### FIELD

The present disclosure is related to rendering webpage content in a website. In particular, the present disclosure relates to systems and methods for dynamically rendering webpage content based on a template selected for the webpage.

### BACKGROUND

In general, templates are used for generation of webpages in a website. A template, which is also known as a web template, may specify the look and feel of a rendered webpage. Users may work with templates to automatically generate webpages, through a web interface or application. A template can render a webpage based on static content, as well as structure and appearance elements.

However, static content and layout may not satisfy the needs of users who may wish to have different content or layout populated for a number of webpages using the same template.

### SUMMARY

Example methods and systems for rendering content based on a template are disclosed. In particular, example systems and methods for rendering a webpage dynamically based on a template and a list of content are disclosed. The template may include one or more sections, each section having a respective section header. The list of content may include one or more metafields, and each metafield may include a reference to a content body for some of the one or more sections. When the metafield does not have substantive content for a content body of a section in the template, the section is skipped when rendering the webpage.

Some examples of the present disclosure may be implemented in the context of an online platform, such as an e-commerce platform, that hosts online stores. The disclosed example methods and systems enable the dynamic presentation of sections against a known and selected template in the online platform where every presentation is made through a pre-selected template composed of multiple sections. This allows for the wide application of the templates against the plurality of products in an online store instead of customizing the presentation of each product or selecting multiple templates to accommodate all products in the store.

Instead of rendering a BLANK section (e.g., a section of white space) or a section with only a section header when a section in a template has no corresponding content, the proposed method skips the section entirely when attempting to retrieve a content body for the specific section. For example, the system, such as a template engine, may determine that a section does not include corresponding content when the attempt to retrieve content body returns a null value. The null value may be returned by a content server based on a metafield associated with the specific section. The corresponding content here means substantive content, excluding programming logic data. For example, a section may include programming logic data such as tags or wrappers, but not substantive content, in which case the section is still considered not to have corresponding or substantive content.

The example methods and systems disclosed herein provide the technical effect that, by enabling a webpage to be rendered dynamically based on a template and a list of content, computing resources are used in a more efficient manner. A template can be dynamically adapted for different content, without having to use memory resources to maintain a larger variety of templates to suit all possible content. Further, by skipping rendering of a section entirely when a template section has no corresponding content, computing resources (e.g., processing power and memory resources) are not wasted on rendering a section without useful content. Thus, at least in some examples, the present disclosure provides technical improvements in the functioning of a computing system.

In some example aspects, the present disclosure describes a computer-implemented method for rendering content based on a template, the method may include: receiving a rendering request for a webpage, the rendering request comprising a template identification (ID) and a reference to a list of content; retrieving a template based on the template ID, the template comprising one or more sections; retrieving a respective content body for each of the one or more sections in the template, based on the list of content; determining that a respective content body for a first section from the one or more sections does not include substantive content; and responsive to determining that the respective content body for the first section does not include substantive content, causing a render of the webpage to omit the first section from a display of the one or more sections on the webpage.

In some embodiments, each of the one or more sections may include a respective section header.

In some embodiments, determining that the respective content body for the first section does not include substantive content includes: determining that the respective content body for the first section comprises a null value.

In some embodiments, the respective content body for the first section comprises programming logic data for the first section.

In some embodiments, the method may further include: causing the render of the webpage to display a second section, based on the respective section header for the second section and the respective content body for the second section.

In some embodiments, the list of content may include a metafield.

In some embodiments, the metafield may include the respective content body for one section of the one or more sections in the template.

In some embodiments, the metafield may include a reference to the respective content body for one section of the one or more sections in the template.

In some embodiments, the list of content may include a metafield for each section of the one or more sections in the template.

In some example aspects, the present disclosure describes a system for rendering content based on a template, the system comprising a processor in communication with storage, the processor configured to execute instructions from the storage to cause the system to: receive a rendering request for a webpage, the rendering request comprising a template identification (ID) and a reference to a list of content; retrieve a template based on the template ID, the template comprising one or more sections; retrieve a respective content body for each of the one or more sections in the template, based on the list of content; determine that a respective content body for a first section from the one or more sections does not include substantive content; and responsive to determining that the respective content body for the first section does not include substantive content, cause a render of the webpage to omit the first section from a display of the one or more sections on the webpage.

In some embodiments, each of the one or more sections may include a respective section header.

In some embodiments, determining that the respective content body for the first section does not include substantive content includes: determining that the respective content body for the first section comprises a null value.

In some embodiments, the respective content body for the first section comprises programming logic data for the first section.

In some embodiments, the processor is configured to execute instructions from the storage to further cause the system to: cause the render of the webpage to display a second section, based on the respective section header for the second section and the respective content body for the second section.

In some embodiments, the list of content may include a metafield.

In some embodiments, the metafield may include the respective content body for one section of the one or more sections in the template.

In some embodiments, the metafield may include a reference to the respective content body for one section of the one or more sections in the template.

In some embodiments, the list of content may include a metafield for each section of the one or more sections in the template.

In some examples, the system may implement an e-commerce platform.

In some examples, the processor may be configured to execute instructions to cause the system to perform any of the methods described herein.

In some example aspects, the present disclosure describes a computer-readable medium storing instructions that, when executed by a processor of a system, cause the system to: receive a rendering request for a webpage, the rendering request comprising a template identification (ID) and a reference to a list of content; retrieve a template based on the template ID, the template comprising one or more sections; retrieve a respective content body for each of the one or more sections in the template, based on the list of content; determine that a respective content body for a first section from the one or more sections does not include substantive content; and responsive to determining that the respective content body for the first section does not include substantive content, cause a render of the webpage to omit the first section from a display of the one or more sections on the webpage.

In some examples, the computer-readable medium, when executed by the processor, may cause the system to perform any of the methods described herein.

### BRIEF DESCRIPTION OF THE DRAWINGS

Reference will now be made, by way of example, to the accompanying drawings which show example embodiments of the present application, and in which:

FIG. 1 is a schematic diagram showing an administrator view including a template displayed on a user device, in accordance with some example embodiments.

FIG. 2A is a schematic diagram showing an example list of content and a content server, in accordance with some example embodiments.

FIG. 2B shows two example webpages rendered by a template engine 1000 in FIG. 1.

FIG. 3 is a flowchart illustrating an example method for rendering webpages based on a template, which may be implemented using the template engine shown in FIG. 1.

FIG. 4 is a block diagram of an example e-commerce platform, in which examples described herein may be implemented.

FIG. 5 is an example homepage of an administrator, which may be accessed via the e-commerce platform of FIG. 4.

FIG. 6 is another block diagram of the e-commerce platform of FIG. 4, showing some details related to the template engine.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DESCRIPTION OF EXAMPLE EMBODIMENTS

Various representative embodiments of the disclosed technology will be described more fully hereinafter with reference to the accompanying drawings. The present technology may, however, be embodied in many different forms and should not be construed as limited to the representative embodiments set forth herein.

It will be understood that when an element is referred to as being “connected” or “coupled” to another element, it can be directly connected or coupled to the other element, or intervening elements may be present (e.g., indirect connection or coupling). By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Additionally, it will be understood that elements may be “coupled” or “connected” mechanically, electrically, communicatively, wirelessly, optically, and so on, depending on the type and nature of the elements that are being coupled or connected.

The functions of the various elements shown in the figures, including any functional block labeled as a “processor,” may be provided through the use of dedicated hardware as well as hardware capable of executing instructions, in association with appropriate software instructions. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term “processor” should not be construed to refer exclusively to hardware capable of executing software, and may implicitly include, without limitation, an application-specific integrated circuit (ASIC), a field-programmable gate array (FPGA), a read-only memory (ROM) for storing software, a random access memory (RAM), and non-volatile storage. Other hardware, conventional and/or custom, may also be included.

Software modules, or simply modules or units which are implied to be software, may be represented herein as any combination of flowchart elements or other elements indicating the performance of process or operation steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities. It will further be understood that a “module” generally defines a logical grouping or organization of related software code or other elements as discussed above, associated with a defined function. Thus, one of ordinary skill in the relevant arts will understand that particular code or elements that are described as being part of a “module” may be placed in other modules in some implementations, depending on the logical organization of the software code or other elements, and that such modifications are within the scope of the disclosure as defined by the claims.

The present technology may be implemented as a system, a method, and/or a computer program product. The computer program product may include a computer-readable storage medium (or media) storing computer-readable program instructions that, when executed by a processor, cause the processor to carry out aspects of the disclosed technology. The computer-readable storage medium may be, for example, an electronic storage device, a magnetic storage device, an optical storage device, an electromagnetic storage device, a semiconductor storage device, or any suitable combination of these. A non-exhaustive list of more specific examples of the computer-readable storage medium includes: a portable computer disk, a hard disk, a random access memory (RAM), a read-only memory (ROM), a flash memory, an optical disk, a memory stick, a floppy disk, a mechanically or visually encoded medium (e.g., a punch card or bar code), and/or any combination of these. A computer-readable storage medium, as used herein, is to be construed as being a non-transitory computer-readable medium. It is not to be construed as being a transitory signal, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that computer-readable program instructions can be downloaded to respective computing or processing devices from a computer-readable storage medium or to an external computer or external storage device via a network, for example, the Internet, a local area network, a wide area network and/or a wireless network. A network interface in each computing/processing device may receive computer-readable program instructions via the network and forwards the computer-readable program instructions for storage in a computer-readable storage medium within the respective computing or processing device. Computer-readable program instructions for carrying out operations of the present disclosure may be assembler instructions, machine instructions, firmware instructions, configuration data for integrated circuitry, or either source code or object code written in any combination of one or more programming languages.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures, and combinations of such functions can be implemented by special-purpose hardware-based systems that perform the specified functions or acts or by combinations of special-purpose hardware and computer instructions.

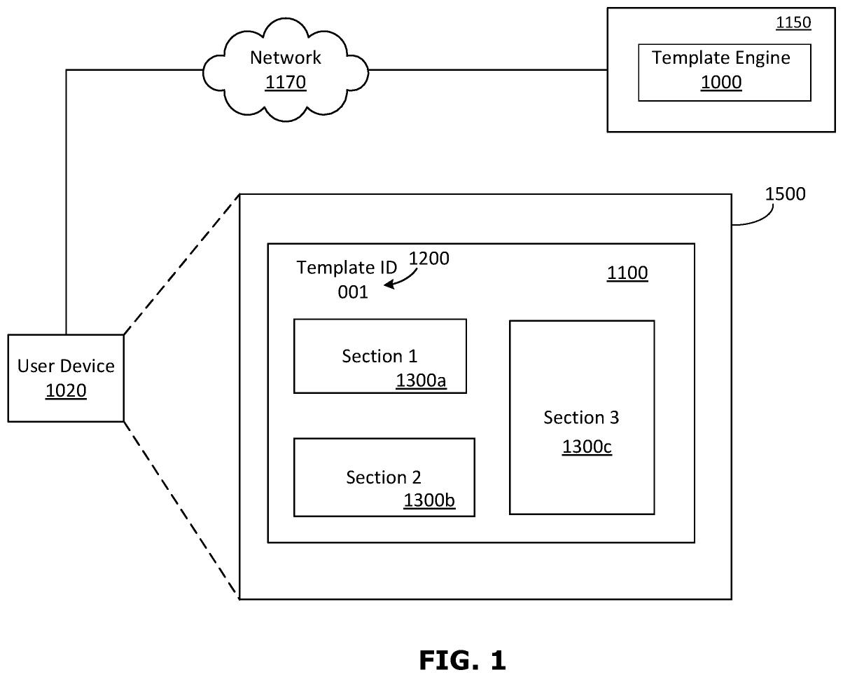

Reference is now made to FIG. 1, which is a schematic diagram showing an administrator view 1500 displayed on a screen of a user device 1020 (e.g., computer, laptop computer, mobile computing device, and the like), in accordance with some example embodiments.

In some embodiments, a user may be authenticated and logged into a user account by a system 1150 including the template engine 1000. The system 1150 may be connected to the user device 1020 via a network 1170 (e.g., the internet) and provide interfaces for generating, editing, or otherwise managing a website or a webpage after the user is logged in. A website may include multiple webpages. For example, the administrator view 1500 shows a template 1100 that may be used to generate a webpage.

As discussed above, templates are used to generate webpages based on content, with a set of pre-populated structure and appearance elements. An example template 1100 may be identified by a template ID 1200 (e.g. “001”), have a number of sections 1300a, 1300b, 1300c, where each section 1300a, 1300b, 1300c may have a section header (e.g., “Section 1”). Each section 1300a, 1300b, 1300c may be, at rendering time, populated with content from a content server or database.

In some embodiments, sections 1300a, 1300b, 1300c in a template 1100 may define the elements of a page layout, such as slideshows, text blocks, newsletter signups, and collection of images.

In some embodiments, a template 1100 may be generated by the system 1150 based on style sheets, such as, for example, one or more cascading style sheets (CSS), which specify how Hypertext Markup Language (HTML) elements are to be displayed on a screen of a computing device. A template 1100 may also be stored as a .css file.

Generally speaking, a user can use the same template 1100 across the same type or category of webpages. For example, if the user wishes to generate multiple webpages for multiple products in an online store (e.g., a website), an existing “product” template may be used for generating a webpage for each of the multiple products offered for sale on the online store. However, when a product needs to have a rendered webpage that is different from the rest of the products in the online store, the user may need to manually customize the template 1100 for the product's webpage, or pick a different template for the specific product, provided that there is an existing, different template sufficient for rendering the webpage for that product. This can be a rather cumbersome process for the user and may require the system 1150 to store a lot of different templates, including standard and customized templates. Moreover, in reality, most users prefer to avoid customization of templates for different products.

For example, typically, when different webpages need to be rendered, it may be achieved by: 1) individually customizing an existing template 1100 for each webpage; or 2) using a different template for each webpage. The first option requires the user to spend time and effort on the customization; and when a webpage is rendered based on a customized template, the template cannot be updated automatically, as further explained below. The second option requires the system 1150 to provide multiple templates for the same category of webpage (e.g. “product” webpage), or provide variations of each template. Both the first and second options require the storage and management of multiple templates and webpages, which adds overhead and increases the burden on the system 1150 (e.g., increasing the use of memory resources), as well as incurs costs (including computational cost) for management and maintenance for the various templates.

In some embodiments, one or more existing templates 1100 may be updated from time to time at the system 1150 (e.g., an existing template 1100 may be modified or replaced by an administrative user who has authorization to make such a change to the templates 1100). A template update can include updates to images or other content. Typically, a template update that is made at the system 1150 can be propagated to webpages using the template automatically. However, when a user has customized a template, the underlying code for the template may have been changed by the customization, and the customized template cannot be automatically updated. For example, the system 1150 may rely on certain “anchor points” or reference line of code to identify the portion of the template code that should be updated. Such reference code may be changed by the user's customization and no longer useable as a reference for updating the template. In this case, the user would have to manually locate and install the updated template, and further reapply the desired customizations to the updated template.

Webpages using the same template 1100 generally have a common definition of background, layout, or theme with associated basic rendering parameters. Each template 1100 has a set of sections 1300a, 1300b, 1300c, and the content for one or more of these sections 1300a, 1300b, 1300c may vary among the rendered webpages, depending on the content for the respective section retrieved from a content server (or database) at the time of the respective webpage being rendered.

Generally speaking, a group of webpages rendered based on the same template 1100 may have the same general layout, with highly similar look and feel. However, variations of layout may exist among these rendered webpages. For example, the layout of sections in each of the rendered webpage may differ from one to another.

In some embodiments, variations in the sections of a template can generally be accommodated, in the current system 1150, by the use of metafields.

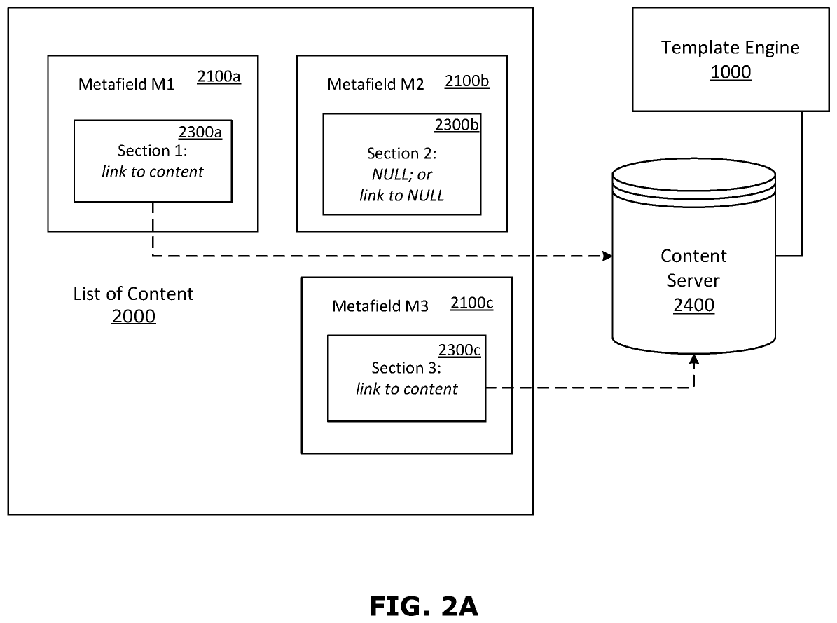

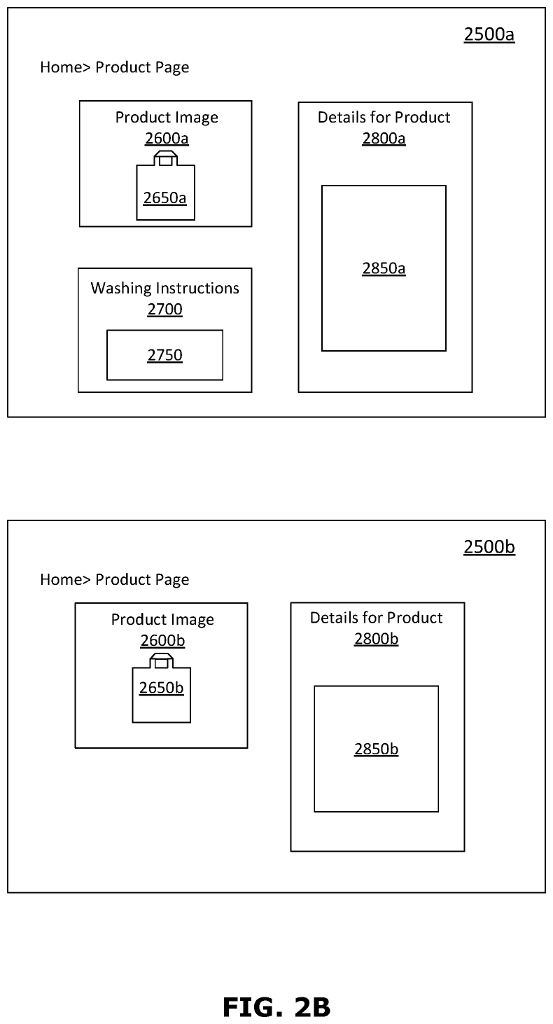

FIG. 2A is a schematic diagram showing an example list of content 2000 and a content server 2400, in accordance with some example embodiments. A list of content 2000, along with a template 1100, may be specified or otherwise generated by the system 1150 based on user input received from the user device 1020 for rendering one or more webpages. In some embodiments, a list of content 2000 may be provided for each of the webpages to be rendered. In other embodiments, a list of content 2000 may be used for multiple webpages to be rendered.

The list of content 2000, which may be a file 2000 stored on the system 1150, may be retrieved and used by the template engine 1000 to render one or more webpages. The list of content 2000 may include one or more metafields 2100a, 2100b, 2100c. Metafields generally facilitate rendering of content for each section 1300a, 1300b, 1300c in a template 1100 for a webpage. More generally, a metafield 2100a, 2100b, 2100c can be viewed as an object containing a content body, or a reference (e.g., a link) to the content body for a specific section 1300a, 1300b, 1300c in the template 1100.

For example, metafield M1 2100a contains a link to content 2300a for section 1 1300a in the template 1100; and metafield M3 2100c contains a link to content 2300c for section 3 1300c in the template 1100. The links to content 2300a, 2300c may point to specific content stored on a content server 2400, which may be connected to the template engine 1000 in the system 1150. In some embodiments, the links may point to specific content stored on a content server 2400 in (or connected to) the system 1150.

It can be seen that metafield M2 2100b does not contain any content body, or any reference to a valid content body, for section 2 1300b in the template 1100. In this case, metafield M2 2100b contains NULL for section 2 1300b in the template 1100, indicating that there is no valid content for this particular section 1300b.

In some embodiments, when a metafield is said to contain “NULL”, it may contain a reference (or link) that points to NULL, which means that the memory location assigned to the reference in the metafield contains a specific value, e.g., the value 0 (i.e., all bits at zero), that denotes NULL in the system 1150.

In some embodiments, when a metafield is said to contain “NULL”, it may contain a null pointer or a null pointer constant, which means that the memory location assigned to the reference in the metafield does not store a valid object (e.g., a void object in programing language C).

The template engine 1000 may determine whether a given metafield 2100a, 2100b, 2100c contains NULL by retrieving the value stored at the memory address specified in a reference or link contained in the metafield. The memory address may point to a memory location in the system 1150, or a memory location in the content server 2400.

As discussed above, sometimes variations may exist for webpages rendered based on the same template 1100. As an example, in an online store, a product A (e.g., a pair of jeans) has washing instructions, and a different product B (e.g., a bottle of hand lotion) does not. The chosen template 1100 may include a “washing instructions” section (e.g., section 2 1300b in FIG. 1) when at least one webpage to be rendered is for a product that has washing instructions.

In this case, based on user input, a metafield may be selected or specified for a respective list of content 2000 for a webpage for each product: for product A, a corresponding metafield for the “washing instructions” section may include a link to a content body specifying washing instructions for product A; and for product B, a corresponding metafield 2100b for the “washing instructions” section may include NULL, or a link to NULL 2300b.

In some embodiments, upon receiving a rendering request from a user device 1020, the system 1150 may retrieve a content body, based on a respective metafield in a list of content 2000 for a specific section in a given template 1100. When the metafield 2100b includes NULL 2300b for the respective section 1300b in the template 1100, the content body is not included for rendering at the user device 1020, but the section header for the respective section 1300b may still be rendered within the corresponding section on the rendered webpage at the user device 1020. Where there is no section header, a blank section with white space may be displayed. As a result, the rendered webpage may appear like there might be missing content, which might cause user confusion, and/or mislead the user into trying to re-render the webpage, thereby wasting computing resources. In addition, as processing power and memory resources are used in generating the appropriate HTML codes on the server side by the system 1150, and again in rendering the webpage using the HTML codes by the user device 1020, some processing power and memory resources are wasted in rendering the blank section for a section that has NULL content body.

As discussed further below, the system 1150 and in particular, the template engine 1000, can be configured, in some embodiments, to omit a section entirely when the section in the template 1100 has no valid content, as determined based on the stored value or reference in a corresponding metafield for that section in the list of content 2000.

FIG. 2B shows two example webpages 2500a, 2500b rendered by a template engine 1000 shown in FIG. 1. Webpage 2500a may be rendered for product A; while webpage 2500b may be rendered for product B. As can be seen, the rendered webpage 2500a for product A has: a section 2600a including a section header “Product Image” and a content body for the section 2650a; a section 2800a including a section header “Details for Product” and a content body for the section 2850a; and a section 2700 including a section header “Washing Instructions” and a content body for the section 2750. In comparison, the rendered webpage 2500b for product B has: a section 2600b including a section header “Product Image” and a content body for the section 2650b; a section 2800b including a section header “Details for Product” and a content body for the section 2850b; and no section for washing instructions.

In some embodiments, a user may customize the look and feel of a website through a template 1100, such as, for example, a template 1100 where users can select and change the look and feel of the website, by changing the theme of the template 1100 while having the same underlying data (e.g., underlying product and business data). It may be that templates 1100 can be further customized through a template editor, a design interface that enables users to customize their website's design with flexibility. Additionally or alternatively, it may be that the template 1100 can, additionally or alternatively, be customized using theme-specific settings such as, for example, settings as may change aspects of a given theme, such as, for example, specific colors, fonts, and pre-built layout schemes. In some embodiments, the system 1150 may implement a content management system for website content. Users may employ such a content management system in authoring blog posts or static pages and publish them to their website, such as through blogs, articles, landing pages, and the like, as well as configure navigation menus. Users may upload images (e.g., for products), video, content, data, and the like to the system 1150, such as for storage by the system (e.g., in the content server 2400). In some embodiments, the system 1150 may provide functions for manipulating such images and content such as, for example, functions for resizing images, associating an image with a product, adding and associating text with an image, adding an image for a new product variant, protecting images, and the like.

After a first user has finished selecting, and if appropriate, customizing a template for each webpage in their website through the administrator view 1500 in FIG. 1, the system 1150 may generate and store a list of content 2000 for each webpage based on the user input. The system 1150 may store a template ID 1200 that has been selected by the user for each webpage. The system may further store the appropriate data in the content server 2400, if and when the first user has uploaded such data for each webpage. In some embodiments, as the first user selects or otherwise inputs, via the administrator view 1500, a metafield for a specific section in a specific template 1100, the system 1150 may automatically prepare a list of content 2000 including the corresponding template ID, the section ID for each metafield.

When a second user visits the website of the first user, the browser on the user device 1020 of the second user may send a request to the system 1150 for rendering a webpage of the website of the first user. The system 1150, upon receiving the request from the user device 1020 of the second user, may call upon the template engine 1000 to generate (e.g., compiling) a HTML file, which is then sent by the system 1150 to the user device 1020. The HTML file may, once processed by the browser (e.g., the browser engine) of the user device 102, cause a rendering of the requested webpage at the user device 102.

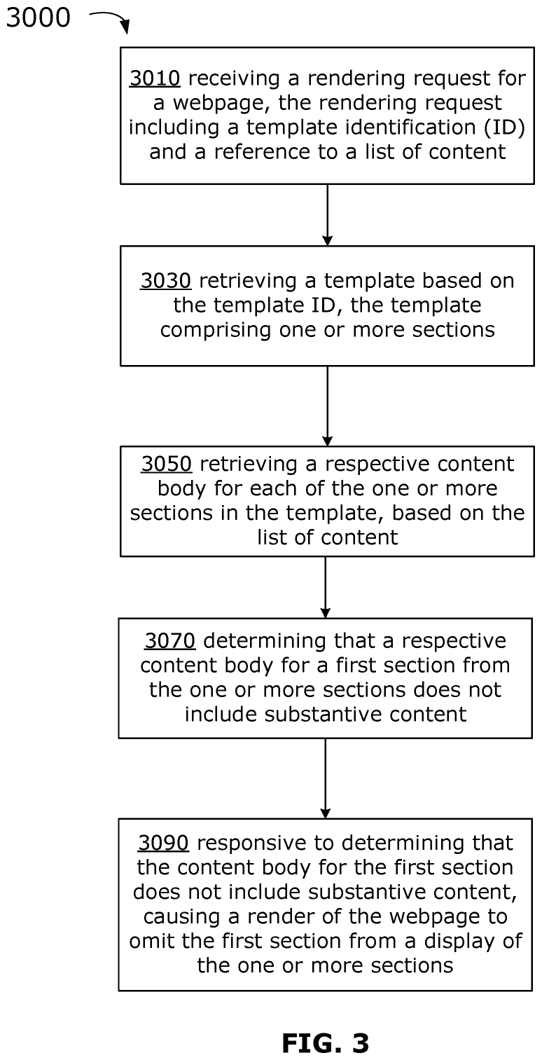

FIG. 3 is a flowchart 3000 illustrating an example method for rendering webpages 2500a, 2500b based on a template 1100, which may be implemented using the template engine 1000 shown in FIG. 1.

At operation 3010, a template engine 1000 may receive a rendering request for a webpage, the rendering request may include a template identification (ID) 1200 and a reference to a list of content 2000. The rendering request may be generated by the system 1150 based on a request sent from a browser engine on a user device 1020, via the network 1170, for rendering a specific webpage.

At operation 3030, the template engine 1000 may retrieve a template 1100 based on the template ID 1200. The template 1100 may be stored on the system 1150 or a content server 2400, and include one or more sections 1300a, 1300b, 1300c. Each of the one or more sections 1300a, 1300b, 1300c may include information for a browser to render the respective section based on a specific layout: e.g., for section 1, the content body is to be placed inside a 200×300 pixel space with black borders. Each of the one or more sections 1300a, 1300b, 1300c may include a respective section header that is also to be rendered by the browser based on a specific layout: e.g., for section 1, the section header is to be placed above the content body.

At operation 3050, the template engine 1000 may retrieve a respective content body for each of the one or more sections 1300a, 1300b, 1300c in the template 1100, based on the list of content 2000. The list of content 2000 may include a metafield 2100a, 2100b, 2100c for each section of the one or more sections 1300a, 1300b, 1300c in the template 1100.

Each metafield 2100a, 2100b, 2100c may, in some embodiments, include reference to a template 1100 (e.g., by way of the template ID 1200) and a specific section 1300a, 1300b, 1300c within the template 1100. For example, the metafield 2100a may include a template ID 1200 and a section ID in addition to the content body. In some embodiments, the rendering request sent to the template engine 1000 or the list of content 2000 may include the appropriate template ID 1200 and section ID for each metafield. In some embodiments, each metafield 2100a, 2100b, 2100c corresponds to at least one section 1300a, 1300b, 1300c in the template 1100.

Each metafield 2100a, 2100c may, for the respective section 1300a, 1300c in the template 1100, contain a reference (or link) to the corresponding content 2300a, 2300c stored on a content server 2400, which may be connected to the template engine 1000. In some embodiments, the references may point to specific content stored on a content server 2400 in (or connected to) the system 1150.

At operation 3070, the template engine 1000 may determine that a respective content body for a first section 1300b from the one or more sections 1300a, 1300b, 1300c does not include substantive content. For example, the template engine 1000 may attempt to retrieve, from the content server 2400, data for the respective content body for the first section 1300b, and responsive to the attempt, receives nothing in return.

For example, when a user has not entered any content in the respective content body of the first section 1300b when populating a webpage based on the template 1100, the content server 2400 simply may not have any data stored for the respective section 1300b for the template 1100 used to render the webpage. In this case, when the template engine 1000 attempts to retrieve data for the respective content body of the first section 1300b from the content server 2400, the template engine 1000 may get a response indicating that the content body for the first section 1300b does not contain any substantive content. Such a response from the content server 2400 may include an error, an empty set, or a null value, each of which can indicate that the respective content body for the first section 1300b has no substantive content.

The null value may be returned by the content server 2400 based on a metafield associated with the specific section. The null value may be, for example, a value of zero, a “NULL” string or a reference to a memory location storing NULL (e.g., a value with all bits set as zero such as “0000”). For example, when a metafield 2300b corresponding to the first section 1300b contains a reference (or link) that points to NULL, the memory location assigned to the reference in the metafield 2300b contains the value 0 (i.e., all bits at zero) that denotes NULL in the system 1150. In this case, the template engine 1000 may determine that the respective content body for the first section 1300b does not include any substantive content.

For another example, when the metafield 2300b corresponding to the first section 1300b contains a null value or a null constant, the memory location assigned to the reference in the metafield does not store a valid object (e.g., a void object in programing language C). In this case, the template engine 1000 may also determine that the respective content body for the first section 1300b includes the null value, which means that it does not include any substantive content.

For yet another example, when the metafield 2300b corresponding to the first section 1300b contains the string “NULL”, the template engine 1000 may also determine that the respective content body for the first section 1300b does not include any substantive content.

For example, referring back to FIG. 2A, metafield 2100b does not contain any content body, or any reference to a valid content body, for section 1300b in the template 1100. Instead, metafield 2100b contains the value NULL for the section 1300b in the template 1100, indicating that there is no valid content for this particular section 1300b.

In some embodiments, substantive content excludes programming logic data. For example, a section may include programming logic data such as tags or wrappers in the respective content body, but nothing substantive or essential in view of the respective section header, and the section is still considered not to have any substantive content in the respective content body, and would not be rendered in the next subsequent operation 3090.

At operation 3090, the template engine 1000 may, responsive to determining that the respective content body does not include any substantive content for the first section 1300b, cause a render of the webpage to omit the first section from a display of the one or more sections on the webpage. For example, the template engine 1000 may be configured to disregard the first section 1300b in the template 1100 when generating the HTML file for the user device 1020 based on the rest of the sections 1300a, 1300c in the template 1100. In other words, the template engine 1100 may exclude the section header, as well as any formatting, stylizing, and/or any other layout parameters associated with the first section 1300b from the HTML file.

The template engine 1000 may, upon determining that the respective content body received in a response from the content server 2400 includes substantive content for a second section 1300a in the template 1100, include the section header and the respective content body for that section 1300a in the HTML file, which then may cause a render of the webpage to display the second section 1300a, based on the respective section header for the second section 1300a and a respective content body for the second section 1300a.

The template engine 1000 may, upon determining that the respective content body received in a response from the content server 2400 includes substantive content for a third section 1300c in the template 1100, include the section header and the respective content body for that section 1300c in the HTML file, which then may cause a render of the webpage to display the third section 1300c, based on the respective section header for the third section 1300c and a respective content body for the third section 1300c.

The rendering request may also include other components, including, for example, reference to third party advertisements which may modify a given content body for a section, a set of customizations that merchant has globally set, and so on. All of these may be processed by the template engine 1000 in order to compile the HTML file that is to be sent to the user device 1020 via the network 1170.

As previously discussed, some existing methods for rendering a webpage may generate a blank section (with or without a section header) when NULL is detected in an attempt to retrieve the content body for a particular section. The process 3000 described above is configured to dynamically determine whether a given section 1300b in a template 1100 contains substantive content and to omit that section 1300b from being rendered if the corresponding metafield does not contain substantive content (e.g., when it contains an empty set or a null value). For example, instead of including, in the HTML file, the section header for each section in the template 1100 regardless of content body, the template engine 1000 only includes, in the HTML file, a section when there is proper, substantive content stored at the corresponding metafield for that section, providing a more sophisticated look for the final, rendered webpage, and enabling more efficient use of computing resources.

The disclosed methods and systems can facilitate a dynamic presentation of sections against a known and selected template in a system where every presentation is made through a pre-selected template including multiple sections. This allows an easy and wide application of templates against the plurality of webpages in a website, instead of customizing the presentation of each webpage or selecting multiple templates to accommodate all the webpages in a website. In some examples, the disclosed methods and systems may be implemented in the context of an e-commerce platform. For example, the system 1150 may be (or may be part of) an e-commerce platform, and/or the template engine 1000 may be part of an e-commerce platform.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

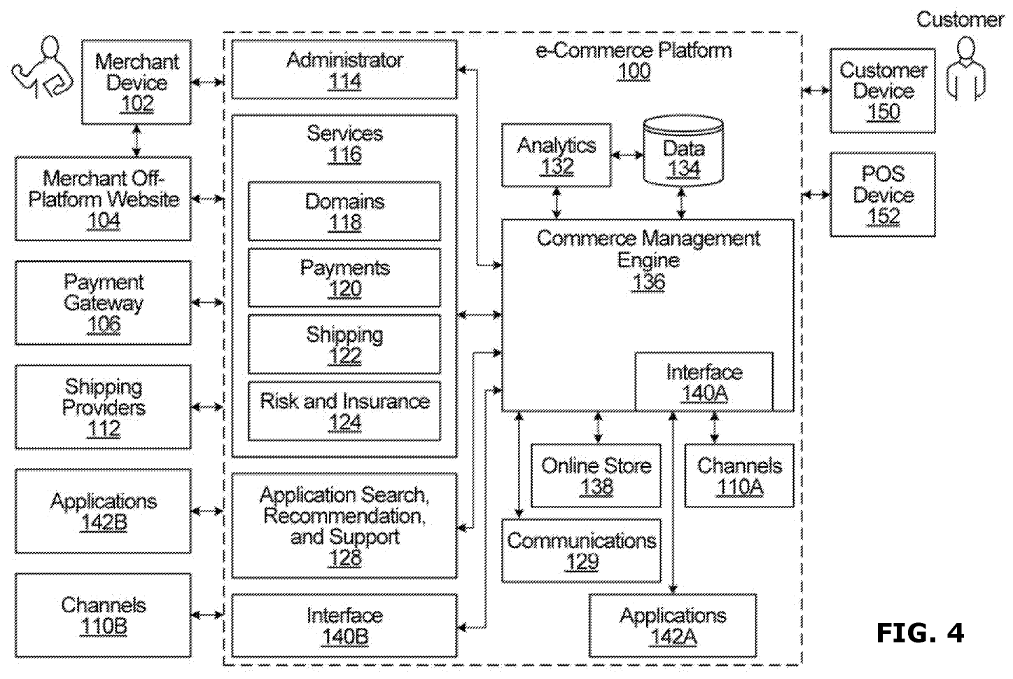

FIG. 4 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 4, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

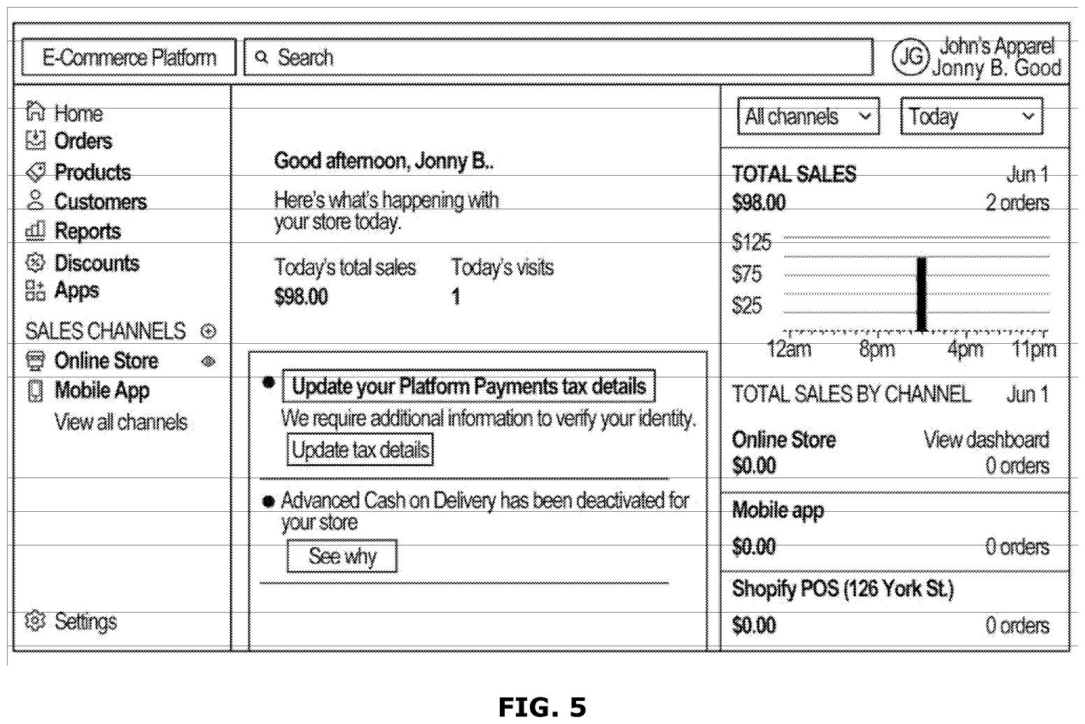

FIG. 5 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 5. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 4, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Implementation in an e-Commerce Platform

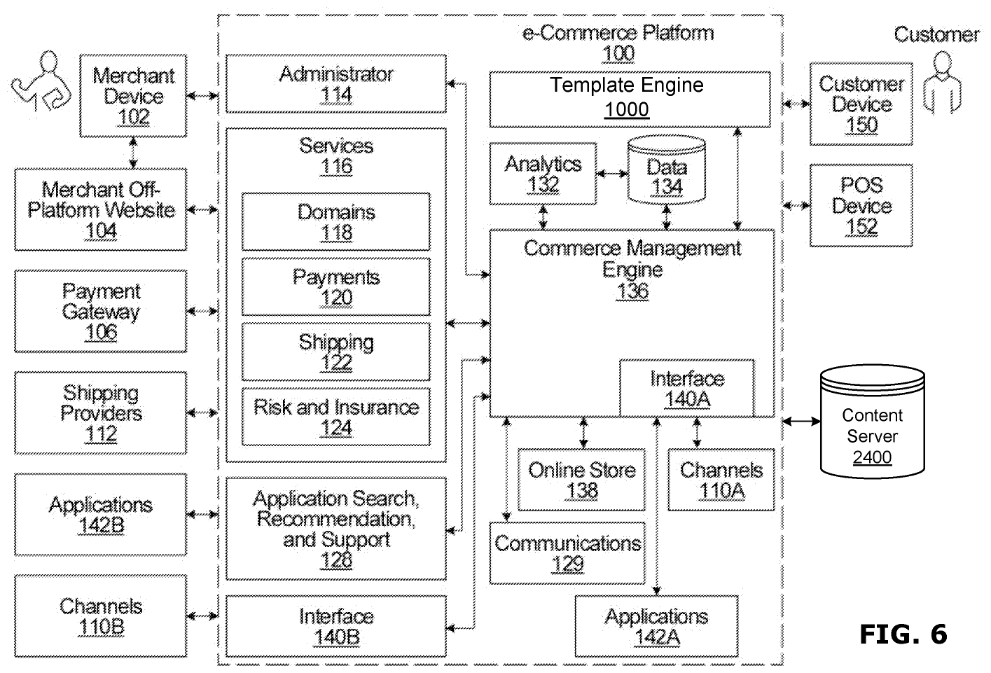

The functionality described herein may be used in commerce to provide improved customer or buyer experiences. The e-commerce platform 100 could implement the functionality for any of a variety of different applications, examples of which are described elsewhere herein. FIG. 6 illustrates the e-commerce platform 100 of FIG. 4 but including a template engine 1000. The template engine 1000 is an example of a computer-implemented system that implements the functionality described herein for use by the e-commerce platform 100, the customer device 150 and/or the merchant device 102. The e-commerce platform 100 may be an example of the system 1150 in FIG. 1. The merchant device 102 may be an example of the user device 1020 for generating a list of content 2000 based on template selection and customization. The merchant device 102 and the customer device 150 each may be an example of the user device 1020 for requesting a rendering of one or more pages based on the list of content 2000 and the template 1100.

Although the template engine 1000 is illustrated as a distinct component of the e-commerce platform 100 in FIG. 6, this is only an example. A template engine 1000 could also or instead be provided by another component residing within or external to the e-commerce platform 100. In some embodiments, the template engine 1000 may be implemented as part of the commerce management engine 136.

Although the content server 2400 is illustrated as a distinct component connected to the e-commerce platform 100 in FIG. 6, this is only an example. A content server may also be part of the e-commerce platform 100. Optionally, the list of content 2000 as well as the content body (e.g., product information) for each webpage may be stored within data 134 of the e-commerce platform 100.

In some embodiments, the administrator view 1500 may be provided by the administrator facility 114. Merchants, which are users of the e-commerce platform 100, may use the administrator facility 114 to customize the look and feel of their website through a template 1100, such as, for example, a template 1100 where merchants can select and change the look and feel of an online store 138, by changing the theme of the template 1100 while having the same underlying product and business data. It may be that templates 1100 can be further customized through a template editor provided by the administrator facility 114, a design interface that enables users to customize their website's design with flexibility. Additionally or alternatively, it may be that a template 1100 can, additionally or alternatively, be customized using theme-specific settings such as, for example, settings as may change aspects of a given theme, such as, for example, specific colors, fonts, and pre-built layout schemes. In some implementations, the e-commerce platform 100 may implement a content management system for website content. Merchants may employ such a content management system in authoring blog posts or static pages and publish them to their website, such as through blogs, articles, landing pages, and the like, as well as configure navigation menus. Merchants may upload images (e.g., for products), video, content, data, and the like to the e-commerce platform 100.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
receiving a request to generate a webpage, the request comprising a template identification (ID) and a reference to a list of content;
retrieving a template based on the template ID, the template comprising one or more sections;
retrieving a respective content body for each of the one or more sections in the template, based on the list of content; and
generating the webpage based on the template and the respective content body for each of the one or more sections in the template, the generating comprising:
determining that a respective content body for a first section from the one or more sections does not include substantive content; and
responsive to determining that the respective content body for the first section does not include substantive content, omitting the first section from the generated webpage.

2. The method of claim 1, wherein each of the one or more sections comprises a respective section header.

3. The method of claim 1, wherein determining that the respective content body for the first section does not include substantive content comprises: determining that the respective content body for the first section comprises a null value.

4. The method of claim 1, wherein the respective content body for the first section comprises programming logic data for the first section.

5. The method of claim 2, wherein generating the webpage further comprises:
rendering of the webpage with a second section, based on the respective section header for the second section and the respective content body for the second section.

6. The method of claim 1, wherein the list of content comprises a metafield.

7. The method of claim 6, wherein the metafield comprises the respective content body for one section of the one or more sections in the template.

8. The method of claim 6, wherein the metafield comprises a reference to the respective content body for one section of the one or more sections in the template.

9. The method of claim 1, wherein the list of content comprises a metafield for each section of the one or more sections in the template.

10. A system comprising a processor in communication with storage, the processor configured to execute instructions from the storage to cause the system to:
receive a request to generate a webpage, the request comprising a template identification (ID) and a reference to a list of content;
retrieve a template based on the template ID, the template comprising one or more sections;
retrieve a respective content body for each of the one or more sections in the template, based on the list of content; and
generate the webpage based on the template and the respective content body for each of the one or more sections in the template, the generations comprising:
determine that a respective content body for a first section from the one or more sections does not include substantive content; and
responsive to determining that the respective content body for the first section does not include substantive content value for the first section, omitting the first section from the generated webpage.

11. The system of claim 10, wherein each of the one or more sections comprises a respective section header.

12. The system of claim 10, wherein determining that the respective content body for the first section does not include substantive content comprises:
determining that the respective content body for the first section comprises a null value.

13. The system of claim 10, wherein the respective content body for the first section comprises programming logic data for the first section.

14. The system of claim 11, wherein the processor is configured to execute instructions from the storage to further cause the system to:
generate the webpage by rendering the webpage to display with a second section, based on the respective section header for the second section and the respective content body for the second section.

15. The system of claim 10, wherein the list of content comprises a metafield.

16. The system of claim 15, wherein the metafield comprises the respective content body for one section of the one or more sections in the template.

17. The system of claim 15, wherein the metafield comprises a reference to the respective content body for one section of the one or more sections in the template.

18. The system of claim 10, wherein the list of content comprises a metafield for each section of the one or more sections in the template.

19. A non-transitory computer-readable medium storing instructions that, when executed by a processor of a system, cause the system to:
receive a request to generate a webpage, the request comprising a template identification (ID) and a reference to a list of content;
retrieve a template based on the template ID, the template comprising one or more sections;
retrieve a respective content body for each of the one or more sections in the template, based on the list of content; and
generate the webpage based on the template and the respective content body for each of the one or more sections in the template, the generation comprising:
determine that a respective content body for a first section from the one or more sections does not include substantive content; and
responsive to determining that the respective content body for the first section does not include substantive content, omit the first section from the generated webpage.

20. The non-transitory computer-readable medium of claim 19, wherein determining that the respective content body for the first section does not include substantive content comprises: determining that the respective content body for the first section comprises a null value.
